(19) United States
(12) Patent Application Publication
(10) Pub. No.: US 2024/0255624 A1
(43) Pub. Date: Aug. 1, 2024

(54) FILTERING A STREAM OF EVENTS FROM AN EVENT-BASED SENSOR

(71) Applicant: Terranet Tech AB, Lund (SE)

(72) Inventor: Dmytro PARKHOMENKO, Kyiv City (UA)

(21) Appl. No.: 18/692,272

(22) PCT Filed: Aug. 23, 2022
(86) PCT No.: PCT/EP2022/073466

§ 371 Date: Mar. 14, 2024

(30) Foreign Application Priority Data
Sep. 24, 2021 (SE) 2151174-6

(51) Int. Cl. G01S 7/487; G01S 7/4863; G01S 17/42; G01S 17/894

(52) U.S. Cl. CPC G01S 7/4876; G01S 7/4863; G01S 17/42; G01S 17/894

(57) ABSTRACT

A computer-implemented method is performed to filter an incoming stream of events from an event-based sensor. Each event in the stream originates from an activated pixel in a pixel array of the event-based sensor and comprises an identifier of the pixel and an associated time stamp. The pixel is activated by photons from a scanning light beam. The method is based on the provision and updating of a data structure that spatially corresponds to the pixel array and has a data element for each pixel. The method updates (403) the data structure, based on the stream of events, so that each data element stores a time value that represents the most recent time stamp associated with the pixel that corresponds to the data element. The thus-updated data structure represents the events by both spatial and temporal data and enables the method to perform a spatio-temporal filtering (404) of the data structure to generate a filtered stream of events.

### TECHNICAL FIELD

The present disclosure relates to data processing in relation to imaging systems, in particular imaging systems that comprise an event-based sensor arranged to receive photons reflected or scattered by a voxel on an object when illuminated by a scanning light beam.

### BACKGROUND

Image sensors in conventional digital cameras capture two-dimensional (2D) digital images that represent the incident photons on individual pixels of a 2D pixel array within an exposure time period. The number of pixels in the pixel array may be large, resulting in a high computational load for processing of the digital images.

Three-dimensional (3D) image-based positioning conventionally uses a plurality of digital cameras, which are arranged to view a scene from different angles. The digital cameras are operated in synchronization to capture a respective time sequence of digital images. A time sequence of 3D representations of any object located in the scene is generated by processing concurrent digital images from different digital cameras by triangulation. This image-by-image processing is processing intensive and difficult to perform in real time, at least if computational resources are limited.

To mitigate these problems, U.S. Ser. No. 10/261,183 proposes a different type of system for 3D positioning. The system includes a transmitter configured to scan a light beam across the scene, and a plurality of digital cameras arranged to view the scene from different angles. As the light beam hits a voxel on an object in the scene, photons are reflected or scattered off the object. Some of these photons impinge on the pixel array of the respective digital camera and produce a local signal increase. Based on the location of the local signal increase on each pixel array, a 3D position of the illuminated voxel may be determined by triangulation. As the light beam scans the object, the resulting 3D positions may be compiled into a 3D representation of the object. This technique significantly reduces the amount of image data that needs to be processed for 3D positioning, in particular if the digital cameras are so-called event cameras. In an event camera, each pixel operates independently and asynchronously to report a change in brightness as it occurs, and staying silent otherwise. Each activation of a pixel forms an event. The event camera outputs a continuous stream of such events, where each event may be represented by an identifier of the activated pixel and a timestamp of its activation.

While the system proposed in U.S. Ser. No. 10/261,183 is capable of reducing the amount of image data and speed up processing, it is inherently sensitive to stray light, for example originating from ambient light, or being caused by secondary reflections of the light beam. The stray light will activate further pixels on the pixel array and potentially make it difficult to identify the events that originate from the same voxel on the object. Similarly, sensor noise may result in pixel activation. To some degree, stray light may be suppressed by use of optical bandpass filters that are adapted to transmit the light beam. However, this is typically not sufficient. U.S. Ser. No. 10/261,183 recognizes this problem and proposes two solutions. One proposed solution is to predict the future trajectory of the light beam reflection on the pixel array by Kalman filter processing and to mask out pixels outside the predicted trajectory to favor detection of relevant events. Another proposed solution is to compare the timing of events on different cameras and select events that are sufficiently concurrent as relevant events. These proposals are computationally slow and prone to yield false positives and/or false negatives. Further, the need to compare data from different cameras puts undesired constraints on the processing of the data streams from the event cameras.

The prior art also comprises EP3694202, which proposes to store incoming events from an event camera in a data structure with data elements that correspond to individual pixels of the event camera. As events are received during a timeslot, a map of information elements corresponding to the pixels is built by adding a dedicated value to the information elements that are represented in the incoming events. The data structure is then updated by adding timestamps of the incoming events during the timeslot to the data elements that are identified by the dedicated value in the map. The use of a timeslot is stated to reduce noise on the timestamps but also reduces temporal accuracy since event timing variations within the timeslot are ignored. The data structure is implemented to facilitate 3D reconstruction, by enabling stereo matching of pairs of events respectively received from two event cameras and stored in a respective data structure.

It is known as such to separately perform a temporal filtering and a spatial filtering of data from an event camera, for example to limit the data rate from an event camera as described in US2020/0372254, or to detect blinking light sources as described in US2021/0044744.

The prior art also comprises US2016/0139795 which is directed to detecting movement of an object based on events generated by an event camera with non-scanning illumination of a scene.

### SUMMARY

It is an objective to at least partly overcome one or more limitations of the prior art.

It is also an objective to provide a processing-efficient technique of filtering a stream of events from an event-based sensor.

A further objective is to provide such a filtering technique which is independent of streams of events from other event-based sensors.

One or more of these objectives, as well as further objectives that may appear from the description below, are at least partly achieved by a computer-implemented method, a processing device, and a system according to the independent claims, embodiments thereof being defined by the dependent claims.

A first aspect of the present disclosure is a computer-implemented method of filtering a data stream of events from an event-based sensor, which comprises a pixel array and is arranged to receive photons reflected or scattered by a voxel on an object when illuminated by a scanning light beam, wherein each event in the data stream originates from a pixel in the pixel array and comprises an identifier of the pixel and a time stamp associated with the event. The method comprises: initiating a data structure with data elements corresponding to pixels of the pixel array; receiving the data stream of events; updating the data structure to store time values in the data elements based on the data stream of events, so that a respective time value of a data element represents a most recent time stamp associated with the pixel corresponding to the data element; and performing a spatio-temporal filtering of the data structure to determine a filtered data stream of events.

A second aspect of the present disclosure is a computer-readable medium comprising instructions which, when executed by a processor, cause the processor to the perform the method of the first aspect or any of its embodiments.

A third aspect of the present disclosure is a processing device, which comprises an interface for receiving a data stream of events from an event-based sensor and is configured to perform the method of the first aspect or any of its embodiments.

A fourth aspect of the present disclosure is a system for determining a position of an object. The system comprises: at least one beam scanning device configured to generate a scanning light beam to illuminate the object; and at least one event-based sensor that comprises a pixel array and is arranged to receive photons reflected or scattered by a voxel on the object when illuminated by the scanning light beam, wherein the at least one event-based sensor is configured to generate an event for a pixel in the pixel array when the number of photons received by the pixel exceeds a threshold, wherein said at least one event-based sensor is configured to output events as a respective data stream, wherein each event in the respective data stream comprises an identifier of the pixel and a time stamp associated with the event. The system further comprises: a processing arrangement, which comprises at least one processing device of the second or third aspect and is configured to receive the respective data stream from the at least one event-based sensor and output a respective filtered data stream; and a voxel detection device configured to receive the respective filtered data stream and determine the position of the voxel based thereon.

Still other objectives and aspects, as well as features, embodiments and technical effects will appear from the following detailed description, the attached claims and the drawings.

### BRIEF DESCRIPTION OF DRAWINGS

FIG. 1 is a block diagram of a system for determining 3D positions of voxels on an object by use of event-based sensors.

FIG. 2 is a flow chart of an example method performed in the system of FIG. 1.

FIG. 3A is a top plan view of a pixel array with an overlaid trajectory of incoming light generated by a scanning light beam, FIG. 3B is a block diagram of an example stream of events generated by an event-based sensor, and FIG. 3C is a block diagram of an example arrangement for signal detection and processing in the system of FIG. 1.

FIGS. 4-6 are flow charts of methods and procedures for filtering a stream of events from an event-based sensor in accordance with examples.

FIG. 7A is a schematic illustration of a data structure used in the methods of FIGS. 4-6, and FIGS. 7B-7C show a simplified numeral example to illustrate the use of the data structure for filtering.

FIG. 8A shows a 2D image of events generated by an event sensor for a plurality of sweeps of a light beam across an object, and FIG. 8B shows a corresponding 2D image that has been recreated by use of a stream of events filtered in accordance with an embodiment.

FIG. 9 is a flow chart of an example procedure for direction determination during filtering.

FIG. 10A shows a beam profile in relation to pixels of a pixel array, and FIG. 10B is an example of timing of events generated by one of the pixels as the beam profile is swept along the pixels.

FIG. 11 is a flow chart of an example procedure for providing time values for filtering.

FIG. 12 is a block diagram of a machine that may implement methods disclosed herein.

### DETAILED DESCRIPTION OF EXAMPLE EMBODIMENTS

Embodiments will now be described more fully hereinafter with reference to the accompanying drawings, in which some, but not all, embodiments are shown. Indeed, the subject of the present disclosure may be embodied in many different forms and should not be construed as limited to the embodiments set forth herein; rather, these embodiments are provided so that this disclosure may satisfy applicable legal requirements. Like numbers refer to like elements throughout.

Also, it will be understood that, where possible, any of the advantages, features, functions, devices, and/or operational aspects of any of the embodiments described and/or contemplated herein may be included in any of the other embodiments described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more”, even though the phrase “one or more” or “at least one” is also used herein. As used herein, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments.

It will furthermore be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing the scope of the present disclosure. As used herein, the terms “multiple”, “plural” and “plurality” are intended to imply provision of two or more elements. The term “and/or” includes any and all combinations of one or more of the associated listed elements.

Well-known functions or constructions may not be described in detail for brevity and/or clarity. Unless otherwise defined, all terms (including technical and scientific terms) used herein have the same meaning as commonly understood by one of ordinary skill in the art to which this disclosure belongs.

As used herein, “event-based sensor” or “event sensor” refers to a sensor that responds to local changes in brightness. The sensor comprises light-sensitive elements (“pixels”) that operate independently and asynchronously, by reporting changes in brightness as they occur, and staying silent otherwise. Thus, an event sensor outputs an asynchronous stream of events triggered by changes in scene illumination. The pixels may be arranged in an array that defines a light-sensitive surface. The light-sensitive surface may be one-dimensional (1D) or two-dimensional (2D). The pixels may be based on any suitable technology, including but not limited to active pixel sensor (APS), charge-coupled device (CCD), single photon avalanche detector (SPAD), complementary metal-oxide-semiconductor (CMOS), silicon photomultiplier (SiPM), photovoltaic cell, phototransistor, etc.

As used herein, “beam scanner” refers to a device capable of scanning or sweeping a beam of light in a one, two or three-dimensional pattern. The beam of light may or may not be collimated. The beam scanner comprises a scanning arrangement configured to steer the beam of light. The scanning arrangement may be based on any suitable technology and may comprise one or more mirrors, prisms, optical lenses, acousto-optic deflectors, electro-optic deflectors, etc. In a further alternative, the scanning arrangement may achieve scanning through phase arrays. The beam scanner may further comprise a light source, such as a laser, light emitting diode (LED), light bulb, etc. The light source may provide a continuous or pulsed light beam of a predefined frequency or range of frequencies.

As used herein, “light” refers to electromagnetic radiation within the portion of the electromagnetic spectrum that extends from approx. 10 nm to approx. 14 μm, comprising ultraviolet radiation, visible radiation, and infrared radiation.

Embodiments relate to a technique of filtering the data stream of events generated by an event-based sensor, denoted “event sensor” or “event camera” in the following, to isolate events that originate from a light beam that is scanned across a scene that is viewed by the event sensor. Thus, the filtering aims at generating a filtered stream of events in which events that are unrelated to the light beam are removed or suppressed.

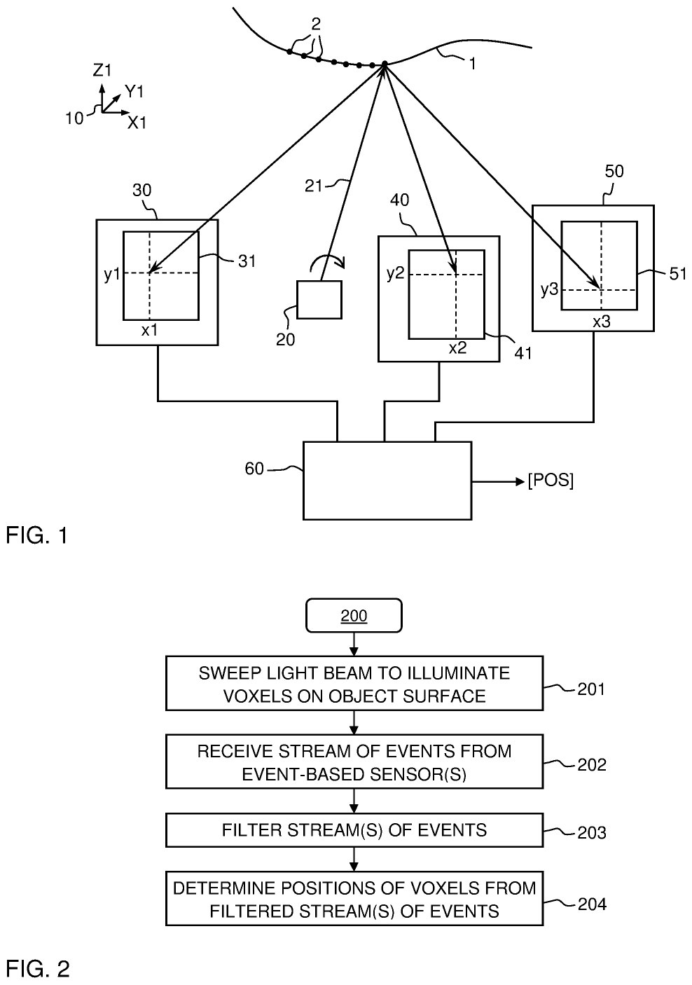

For context, the filtering will be described with reference to an arrangement or system for object detection and positioning shown in FIG. 1.

FIG. 1 is a schematic view of a system comprising three event cameras 30, 40, 50 and a beam scanner 20. Each event camera 30, 40, 50 comprises a respective sensor array or pixel array 31, 41, 51 that defines a two-dimensional (2D) array of light-sensitive elements (“pixels”). The event cameras 30, 40, 50 have a respective field of view facing a scene. The field of views overlap at least partly. Although not shown in FIG. 1, each event camera 30, 40, 50 may comprise one or more optical components that define the field of view, such as optical lenses. The event cameras may also include optical filters. The beam scanner 20 is configured to scan or sweep a beam of light 21 (“light beam”) across the scene in a predefined, random or pseudo-random pattern.

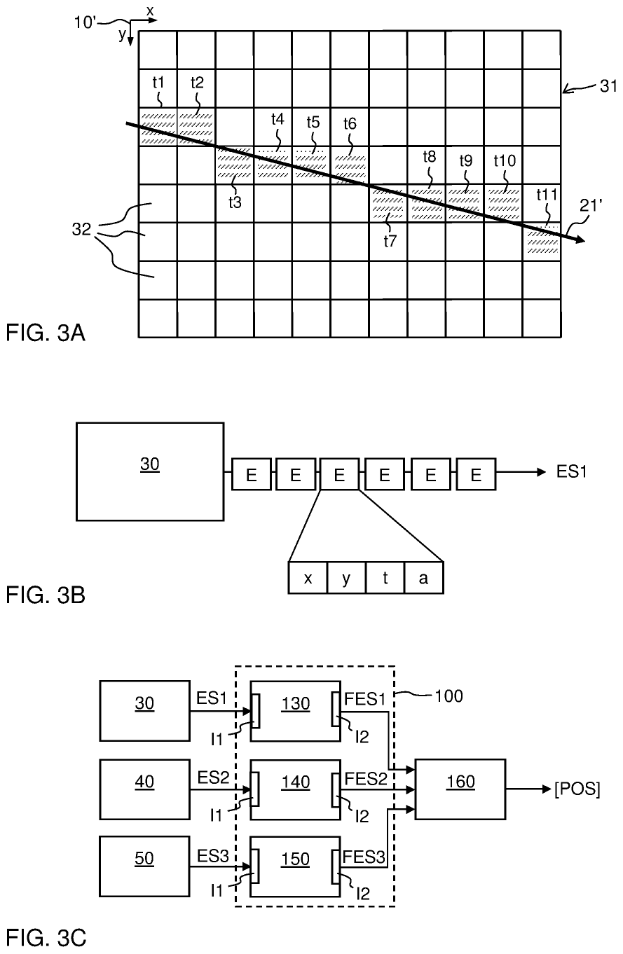

In the illustrated example, the scene includes an object 1, which is illuminated by the light beam 21, which forms a moving spot of light on the object 1. The moving spot thereby sequentially illuminates regions 2 on the object 1. These regions 2, indicated as dark spots in FIG. 1, are also denoted “voxels” herein. A voxel thus refers to a sampled surface element of an object. For each of these illuminated regions, one or more of the cameras (for example, two or three) detect photons reflected or otherwise scattered by that region. In the illustrated example, reflected light from a region is detected by one or more pixels at location (x1,y1) on sensor array 31, at location (x2,y2) on sensor array 41, and at location (x3,y3) on sensor array 51. As noted above, in an event camera, a location is only detected if the number of photons on a pixel exceeds a predefined limit. The “detection location” is given in a predefined local coordinate system of the respective camera 30, 40, 50 (10′ in FIG. 3A). As understood from FIG. 1, scanned voxel illuminations are captured or detected by one or more of the cameras 30, 40, 50, which output a respective stream of events comprising the detection location(s). In some embodiments, each camera autonomously and asynchronously outputs an event whenever a pixel is detected to be illuminated by a sufficient number of photons.

The cameras 30, 40, 50 are connected, by wire or wirelessly, to a processing system 60, such as a computer device, which is configured to receive the streams of events. The processing system 60 is further configured to computationally combine time-synchronized detection locations from different cameras into a stream of voxel positions in three-dimensional (3D) space, for example in the scene coordinate system 10. Thus, each voxel position may be represented by a set of 3D coordinates (X1,Y1,Z1). The processing system 60 may, for example, be configured to compute a voxel position by any well-known and conventional triangulation technique using detection locations from the cameras 30, 40, 50, and calibration data that represents the relative positioning of the cameras 30, 40, 50. The resulting stream of voxel positions, designated by [POS] in FIG. 1, may then be provided to a further processing system, such as a perception system, or be stored in computer memory. It is realized that depending on the scan speed of the light beam, the voxel positions may collectively represent a 3D contour of the object 1 and/or the movement of the object 1 as a function of time within the scene.

The system in FIG. 1 may be stationary or moving. In some embodiments, the system is installed on a moving terrestrial, air-based or waterborne vehicle, and the resulting stream of voxel positions is processed to observe a complex dynamic 3D scene lit up by the scanning light beam. For example, such a 3D scene may be mapped in detail at high detection speed based on the voxel positions. For example, this type of information may be useful to systems for autonomous driving and driver assistance.

The skilled person understands that the sensor arrays 31, 41, 51 may also receive and detect light that does not originate from the light beam 21, for example ambient light that is reflected on the object 1. The ambient light may originate from sunlight or lighting at the scene. Further, the sensor arrays 31, 41, 51 may receive and detect light that originates from the light beam 21 but does not represent a voxel 2, for example secondary reflections of the light beam by the object 1 or other objects (not shown) within the scene. In a practical situation, a significant number of pixels may be activated by this type of unwanted light (“stray light”), resulting in irrelevant events that make the computation of a voxel position difficult or even impossible. Further, electronic noise on the sensor array may also result in erroneously activated pixels. The present disclosure relates to a filtering technique that reduces the impact of stray light and noise. In many applications, real-time or near real-time processing may be required or at least desirable. Thus, in at least some embodiments, it is generally desirable to minimize the latency introduced by the filtering. Further, it may be desirable for the filtering to be efficient, both in terms of memory requirement and processing load, to reduce the cost of the hardware for implementing the filtering, and to limit power consumption.

FIG. 2 is a flow chart of an example method 200, which may be performed by the system in FIG. 1 and includes a filtering technique in accordance with embodiments to be described. In step 201, the beam scanner 20 is operated to scan the light beam 21 within a scene to illuminate voxels 2 on the surface of an object 1. In step 202, which may or may not be performed in real-time, the processing system 60 receives a stream of events from the respective event-based sensor 30, 40, 50. In step 203, the processing device 60 operates a filtration process on the respective stream of events to remove events that are likely to originate from stray light or noise while retaining other events. Step 203 results in a filtered data stream of events for the respective incoming data stream of events. In step 204, the processing device 60 determines voxel positions based on the filtered streams of events.

FIG. 1 is only given as an example of a system for determining a position of an object 1. A larger number of event cameras may be used, for example to increase the accuracy and/or introduce redundancy. Alternatively, a smaller number of event cameras may be used, for example to increase computation speed and/or reduce cost and complexity. It is even possible to determine voxel positions by use of a single event camera, if the relative location between the camera and the beam scanner is known and if the camera is synchronized with the beam scanner so that the angle of the light beam is correlated with the events detected by the camera. In another example, more than one beam scanner may be used to scan light beams within the scene. It is also conceivable that the processing device 60 is configured to determine a single voxel position instead of a stream of voxel positions.

The system in FIG. 1 may be implemented for other purposes than to determine 3D positions. For example, the processing system 60 may be configured to determine the position of voxels in two dimensions or in one dimension in the scene coordinate system 10, for example to track the spot of the beam, based on events from one or more event cameras. It is also conceivable to track the spot of the beam in relative coordinates only. The resulting trajectory of the spot may be used to, for example, detect a deviation indicative of presence of an object in the scene or the passing of an object through the scanning light beam.

FIG. 3A is a plan view of a portion of the sensor array 31 in the event camera 30 in FIG. 1. The sensor array 31 comprises pixels 32 arranged in a rectangular grid. Each pixel 32 is responsive to incident photons. Each pixel 32 has a known location (“pixel location”) in a local coordinate system 10′ and is represented by a unique identifier, index or address, here given as a pair of coordinates (x,y) in the local coordinate system 10′. In some embodiments, each pixel 32 stores a reference brightness level, and continuously compares it to the current level of brightness detected by the pixel. If the difference in brightness exceeds a preset threshold, the pixel 32 resets its reference level and generates an event. Events may also contain the polarity (increase or decrease) of a brightness change and/or an instantaneous measurement of the current level of illumination (“intensity”). The operation and structure of event cameras goes beyond the scope of the present disclosure. For a detailed description of different types of event cameras and their operation, reference is made to the article “Event-based Vision: A Survey”, by Gallego et al., published as arXiv:1904.08405v3 [cs.CV], 8 Aug. 2020, which is incorporated herein in its entirety by reference.

In FIG. 3A, activated pixels are indicated as hatched boxes. An “activated” pixel indicates a pixel that is sufficiently illuminated to generate an event. The pixels are activated by “reflected scanning light”, which is scattered or reflected onto the sensor array as the light beam is swept across the scene. In FIG. 3A, a scan path 21′ of such reflected scanning light is superimposed on the array 31 to illustrate the impact of the beam scan. The pixels are activated sequentially in time in correspondence with the light beam being swept across the scene, starting at time point t1 and ending at time point t11. It may be noted that FIG. 3A presumes that the spot of the light beam 21 on the object 1, as projected onto the array 31, is smaller than a pixel 32. If the projected spot is larger than a pixel, further pixels may be activated along the scan path 21′. FIG. 3B schematically illustrates a stream of events (“event stream”) that may be output by an event camera 30 that comprises the sensor array in FIG. 3A. The event stream is designated by ES1, and each event is designated by E. In the examples presented herein, it is assumed that each event E comprises the index or address of an activated pixel (represented by x, y in FIG. 3B) and a time stamp of the activated pixel (represented by t in FIG. 3C). The time stamp designates the time point of activation of the pixel (cf. t1, . . . , t11 in FIG. 3A) and is set based on the output of a clock in the event camera. The time stamp may be given in any time unit. As indicated by in FIG. 3B, the events E may include further data a, for example the above-mentioned polarity and/or intensity, which may or may not be used by the downstream processing.

In some embodiments, clocks in event cameras may be synchronized, so as to allow the processing device 60 to match corresponding events in the event streams from the different event cameras. Thus, in the example of FIG. 1, the processing device 60 may match the detection locations (x1,y1), (x2, y2) and (x3, y3) based on the time stamps and calculate a voxel position by triangulation. However, in other embodiments, such synchronization is not required.

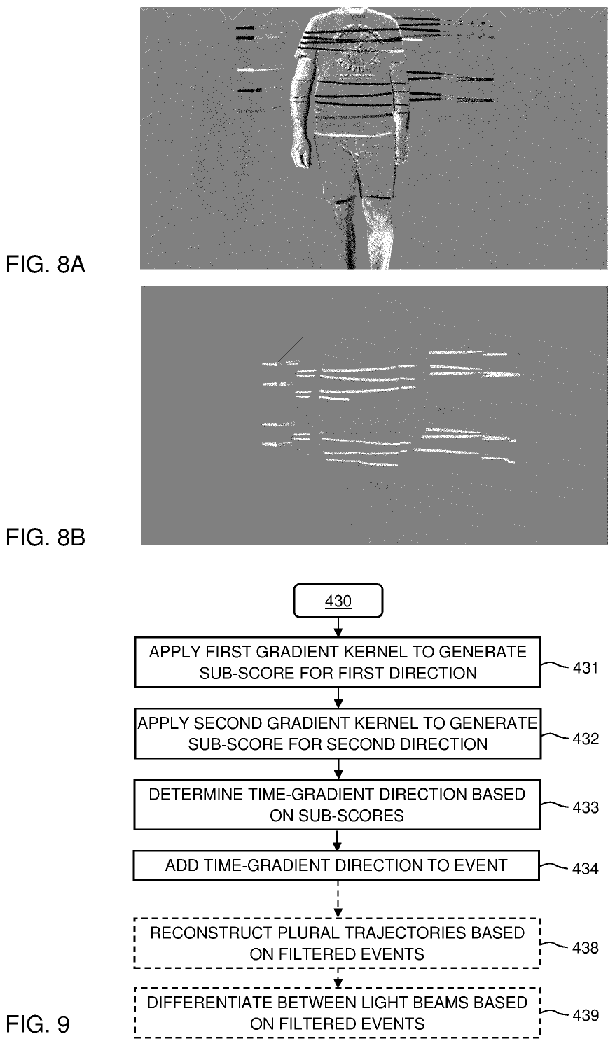

It should be understood that FIG. 3A is an idealized view of the activated pixels resulting from a beam scan. For comparison, FIG. 8A shows a 2D map of pixel activation on the sensor array of an event camera. The 2D map is generated by accumulating the event stream that is output by the event camera while a light beam is scanned in a sparse zig-zag pattern a plurality of times across the scene. A human object moves in the middle of the scene. As seen, the event stream does not only represent the trajectory of the light beam in the scene but also includes contrast changes caused by ambient light that has been reflected by the object. It is realized that the ambient light may impede detection, analysis or processing of the trajectory.

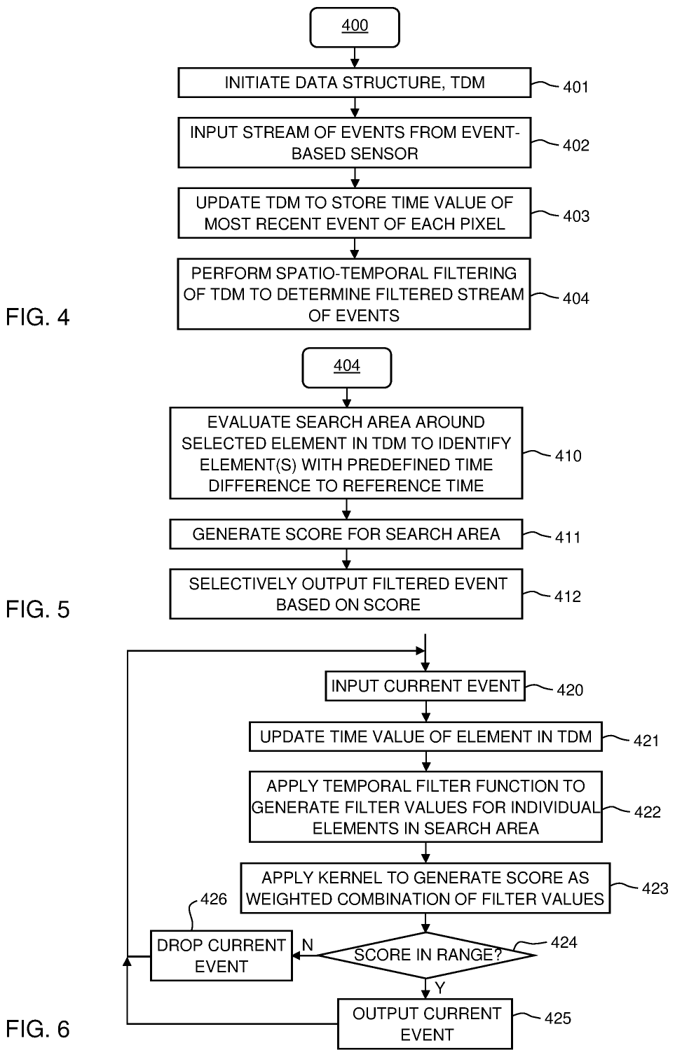

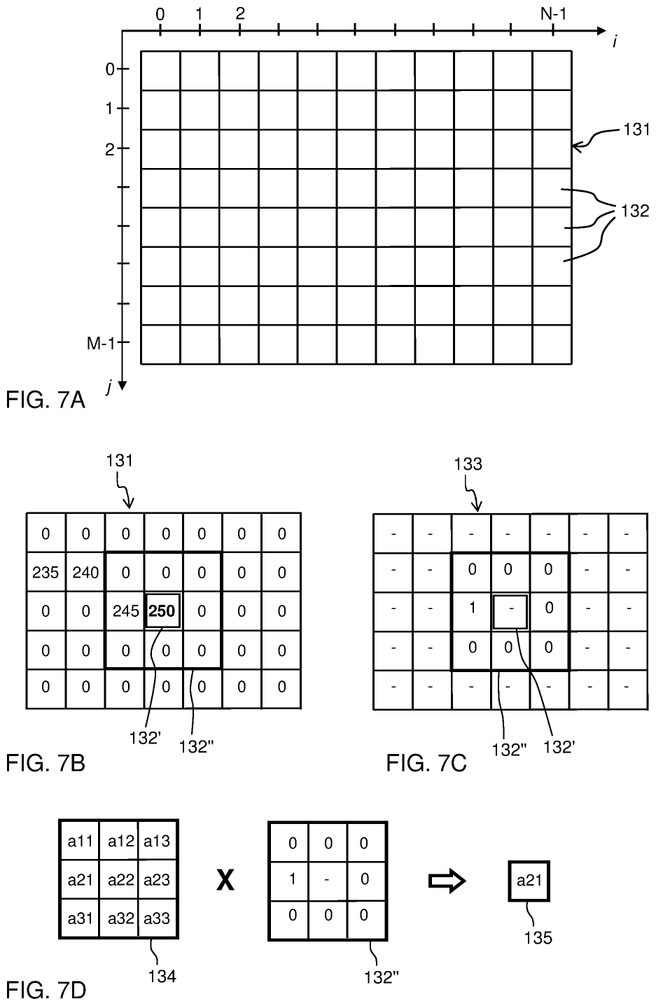

FIG. 4 is a flow chart of an example method 400 of filtering an event stream from an event camera. The example method 400 may be part of step 203 in FIG. 2. In step 401, a dedicated data structure is initiated. The data structure comprises one data element for each pixel, and defines a one-to one spatial mapping of pixels to data elements. Each data element is arranged to store one or more data items. Specifically, each data element is arranged to at least store a time value. FIG. 7A shows a graphical representation of a data structure 131 that corresponds to the sensor array 31 in FIG. 3A.

Each pixel 32 in the sensor array is represented by an addressable data element 132 in the data structure 131. In the illustrated example, the data elements are identified by an index (i,j), with i representing a column on the sensor array and j representing a row on the sensor array. In some implementations, the data structure may be represented in software as one or more arrays or lists. Alternatively, the data structure may be implemented in hardware, for example by an FPGA or an ASIC. The initiation by step 203 may involve an instantiation of an object for the data structure, if implemented in software, and/or an assignment of one or more default values to the respective data element, for example a default time value (cf. 0 in FIG. 7B).

Returning to FIG. 4, step 401 is following by a step 402 in which an event stream is input from an event camera (“event sensor”). As understood from FIG. 3B, the event stream comprises a time sequence of events, which are thus received one by one in step 402. In step 403, the data structure is updated to store time values in the data elements based on the event stream, so that the time value of each data element represents the most recent timestamp that is associated with the corresponding pixel on the sensor array. When a data element is updated with a new time value, the previous time value is overwritten. The data structure, once populated with time values, represents the events by both spatial and temporal data. Thus, the data structure forms a “time distribution map”, also denoted TDM in the following. It may be noted that the respective data element may be updated to store further data in the respective event, such a polarity, intensity, etc. In step 404, a spatio-temporal filtering of the TDM is performed, for example at selected time points during the updating according to step 403, to determine a filtered stream of events (“filtered event stream”). The term “spatio-temporal” implies that the filtering is performed by searching for allowable and/or non-allowable spatio-temporal patterns within the TDM, while passing the allowable patterns and/or blocking the non-allowable patterns for inclusion in the filtered event stream. In other words, the filtering accounts for both the time values and the spatial distribution of the time values in the TDM. The spatio-temporal filtering makes it possible to simply and efficiently identify and remove events that do not correspond to the beam scan across the scene. To this end, the spatio-temporal filtering may be performed based on a known speed of the beam scan, which may be converted into an expected residence time of reflected scanning light that impinges on the respective pixel (cf. scan path 21′ in FIG. 3A). Spatio-temporal filtering as a general concept is known. However, the provision of the data structure according to step 401 and the updating of the TDM with the most recent time values according to step 403 makes it possible to implement spatio-temporal filtering in a processing-efficient way, for example to enable real-time processing of one or more event streams on a conventional processing system.

The rationale for the spatio-temporal filtering will be further explained with reference to FIG. 7B in conjunction with FIG. 3A. If the scan speed of the light beam by the beam scanner (20 in FIG. 1) is known, the expected residence time of reflected scanning light on each individual pixel 32 in the sensor array 31 is also known, at least approximately. Although the expected residence time may not be a fixed and equal value for all pixels, since it also depends on the location and angle of the scan path 21′ in relation to the respective pixel 32, the expected residence time may be set to a nominal value dt, for example an average or maximum value. Assuming that an event is detected by the hatched pixel at time t4 in FIG. 3A, there should be at least one neighboring pixel that has detected an event approximately at time t4−dt. In FIG. 3A, a neighboring pixel detects an event at time t3. If t3 approximately matches t4−dt, it may be concluded that the event at t4 is indeed a correct event, i.e. an event that is located along the scan path 21′. This principle of validating an event detected by a pixel based on time values of events detected by nearby pixels is a spatio-temporal criterion. This criterion may be repeated over time for new events, to thereby gradually validate new events that are detected by the sensor array. The filtering is achieved by only including new events that fulfil the spatio-temporal criterion in the filtered event stream. A numeric example is shown in FIG. 7B, which is a snapshot of the TDM 131 at the time t4 in FIG. 3A. The data elements with non-zero values have been updated for events detected by the hatched pixels t1, t2, t3 and t4 in FIG. 3A, and the values are time values given in microseconds (s). A value of zero (0) is a default value that is assigned at initialization (step 203). For an expected residence time of 5 μs, it can be seen that all events in the TDM 131 comply with the above-mentioned spatio-temporal criterion.

FIG. 5 is a flow chart of a spatio-temporal filtering procedure in accordance with an embodiment. As indicated in FIG. 5, the filtering procedure may be part of step 404 in the method 400 in FIG. 4. Step 410 is performed for a selected data element (SDE) in the TDM and involves an evaluation of the data elements that are located within a search area around the SDE. The evaluation aims at identifying all data elements that store a time value with a predefined time difference (PTD) to the time value stored in the SDE. The data elements identified by step 410 are denoted “complying elements” in the following. Step 411 comprises generating a score for the search area based on the complying element(s). Step 412 then selectively, based on the score, outputs a filtered event that represents the SDE. Step 412 thereby includes the filtered event in the filtered event stream. Step 412 includes the index of the pixel (“pixel location”) corresponding to the SDE in the filtered event and may further replicate the information in the SDE into the filtered event. It is also conceivable that step 412 adds and/or removes data items when generating the filtered event. For example, polarity or intensity, if present in the SDE, may be removed. Such data items may also be removed by not being stored in the data element when the TDM is updated in step 403. In another example, a scanning direction may be added to the filtered event, as described in further detail below with reference to FIG. 9.

In the example of FIG. 7B, step 410 may be performed for the SDE 132′ and the search area 132″. If the PTD is 5 s, step 410 will identify one (1) complying element within the search area 132″. Since this is a reasonable number of complying elements, steps 411-412 may output a filtered event for the pixel that corresponds to the SDE 132′, with the filtered event including the time value of 245 (as well as any further data items stored in the SDE).

As understood from the foregoing, the PTD may correspond to the expected residence time dt. To account for the approximate nature of the expected residence time, the PTD may be given as a range around dt, for example ±10%, ±15% or ±20%.

In some embodiments, the search area has a predefined size. This will enable step 402 to be performed in a fast and deterministic fashion. In the examples given herein, the search area is centered on the SDE. The search area is also symmetrical to the SDE. The search area may, for example, be defined as 3×3 or 5×5 data elements centered on the SRD. However, generally, the search area may have any shape, extent and location in relation to the SDE.

It is conceivable that PTD corresponds to the expected residence time of the scanning light beam on any predefined number of neighboring pixels in the sensor array. The predefined number may be 1 as in the example above, but may alternatively be larger than 1, for example 2 or 3. The skilled person realizes that the search area 132′ may need to be correspondingly extended if the PTD is given for plural pixels. By changing the predefined number of pixels, the characteristics of the spatio-temporal filter is changed. It is currently believed that a predefined number of 1 provides adequate performance.

The use of the PTD as described hereinabove has the additional advantage that the spatio-temporal filtering does not need to be synchronized with the beam scanner (20 in FIG. 1). However, if the filtering is synchronized with the beam scanner, and thus has access to the momentary speed of the scanning light, the PTD may be replaced by an actual time difference, which is adjusted to the momentary speed. The actual time difference may be given as a single value or a range by analogy with the PTD.

In some embodiments, step 410 is performed when the TDM has been updated based on a current event in the event stream from the event camera. This will maximize the throughput of the spatio-temporal filter by avoiding delays in the processing and improving real-time performance. Reverting to FIG. 4, step 403 may update the TDM by the events in the event stream from the array sensor, and step 404 may be performed intermittently while the TDM is updated by step 403. This will enable step 410 to be repeatedly operated on individual and updated snapshots of the TDM, as exemplified in FIG. 7B. This enables processing efficiency and real-time performance. In some embodiments, step 404 is performed whenever the TDM is updated by step 403, i.e. each time the TDM is updated.

In some embodiments, step 410 is repeated for each event in the event stream from the array sensor. Reverting to FIG. 4, step 403 may update the TDM by each event in the event stream from the array sensor, and step 404 may be performed whenever the TDM is updated by step 403.

In some embodiments, the SDE in step 410 is the data element that is updated (by step 403) based in the current event. Thereby, the evaluation in step 410 is performed for a search area around the most recently updated data element. Again, this improves real-time performance. An example is shown in FIG. 7B where the SDE 132′ is the most recently updated data element in the TDM 131.

As understood from the foregoing, the score that is generated by step 411 may be generated as a function of the number of complying elements in the search area as identified by step 410. In some embodiments, the score is generated as a sum of the complying elements around the SDE, weighted by distance. The distance may be given in any unit, for example pixel units. In some embodiments, the weights in the weighted sum may be set to one (1), resulting a score equal to the number of complying elements. However, the present Applicant has surprisingly found that performance may be improved by reducing the weight with increasing distance to the SDE.

In some embodiments, step 412 outputs the filtered event only if the score is within a score range. The score range may extend from a lower value, representing the minimum count that is acceptable for the search area, and an upper value, representing the maximum count that is acceptable for the search area. The score range may be set based on the location and extent of the search area and controls the number of false positives and false negatives among the filtered events.

FIG. 6 is a flow chart of an example procedure that may be included in the method 400 in FIG. 4. The procedure operates on an event stream (cf. ES1 in FIG. 3B). and is arranged to receive and process the events in the event stream one by one. In step 420, which corresponds to step 402, an incoming event in the event stream is input. This event forms a “current event”. The event may be input directly as it is received from the event camera or may be retrieved from a queue in an intermediate buffer. In step 421, the address of the originating pixel (cf. x,y in FIG. 3B) and the time value (cf. t in FIG. 3B) are retrieved from the event. This time value is also denoted “reference time value”, RTV, in the following. The data element that corresponds to the originating pixel is then updated with the RTV, by step 421 overwriting the previous time value stored in this data element. Step 421 thus corresponds to step 403.

In step 422, which is part of step 404 and corresponds to step 410 in FIG. 5, the data element updated by step 421 is used as SDE. A temporal filter function (TFF) is applied to the individual data elements around the SDE within the search area. The TFF thereby generates a filter value for each data element in the search area other than the SDE. The TFF is configured to selectively indicate, by the filter values, all data elements that store time values with the PTD to the RTV. These data elements correspond to the above-mentioned complying elements. In this context, “selectively indicate” implies that the complying elements are assigned different filter values than the other data elements in the search area.

In one example, the TFF is defined as:

$$f 1 ( i , j ) = \{ \begin{matrix}0 if t 0 = t ( i , j ) \\ \frac{dt}{t 0 - t ( i , j )}\end{matrix}$$

Here, f1(i,j) is the filter value for the data element with index (i,j), t0 is the RTV, dt is the expected residence time, and t(i, j) is the time value stored in the data element with index (i,j). This TFF will generate a filter value of zero (0) for data elements that have the same time value as the SDE and a filter value close to one (1) for data elements that have time values close to the expected residence time.

In another example, the TFF is a simplified and processing-efficient step function defined as:

$$f 2 ( i , j ) = \{ \begin{matrix}1 if 0.9 \cdot dt \leq t 0 - t ( i , j ) \leq 1.1 \cdot dt \\ 0\end{matrix}$$

This TFF will generate a filter value of one (1) for data elements with time values that differ from RTV by ±10% of the expected residence time, dt. All other data elements are given a filter value of zero (0). The result of this TFF is exemplified in FIG. 7C, which shows filter values assigned to data elements in the search area 132″ for the time values in FIG. 7B. As seen, only one time value falls within the range of ±10% of dt, which is 5 ps. Although the SDE is not given a filter value in FIG. 7C, it may be set to an arbitrary value, for example to enable the application of a kernel as described below.

Many variations of step 422 are conceivable. For example, although the use of values 0 and 1 may simplify the processing, any other values may be assigned by the TFFs. For example, the value of 1 may be replaced by any other non-zero value. The range of ±10% is likewise given as an example. Further, the skilled person readily understands that there are many other functions that may be used as TFF to achieve the purpose of selectively identifying data elements with certain time values.

In step 423, which is part of step 404 and corresponds to step 411 in FIG. 5, the score is generated as a weighted combination of the filter values from step 422. In some embodiments, as indicated in FIG. 6, the score is generated by applying a predefined kernel to the filter values. This provides a processing efficient way of generating the score. The predefined kernel may be configured to match the data elements in the search area. Such a kernel includes one kernel value (weight) for each data element in the search area. The kernel corresponds to a convolution matrix used in conventional image processing and is applied in the same way, although it is not convoluted but only applied once on the filter values in the search area. Conceptually, the kernel is centered on the search area, and each kernel value is multiplied with its overlapping filter value and all of the resulting values are summed. The result is a weighted sum of the filter values. FIG. 7D shows a 3×3 kernel 134, with kernel values a11, . . . , a33. When applied to the filter values in FIG. 7C, the resulting score 135 is a21.

The kernel may be defined with knowledge about the beam scanning. For example, if the light beam is scanned within the scene back and forth in many different directions, for example pseudo-randomly, the kernel may be defined to be symmetric, i.e. by analogy with a symmetric matrix.

In one example, a symmetric 3×3 kernel may be defined as:

$$ω 1 = [ \begin{matrix}1 & 1 & 1 \\ 1 & 0 & 1 \\ 1 & 1 & 1\end{matrix} ]$$

In another example, a symmetric 5×5 kernel may be defined as:

$$ω 2 = [ \begin{matrix}0.5 & 0.5 & 0.5 & 0.5 & 0.5 \\ 0.5 & 1 & 1 & 1 & 0.5 \\ 0.5 & 1 & 0 & 1 & 0.5 \\ 0.5 & 1 & 1 & 1 & 0.5 \\ 0.5 & 0.5 & 0.5 & 0.5 & 0.5\end{matrix} ]$$

In ω2, the kernel values decrease with increasing distance to the center. This will achieve the above-mentioned feature of reducing the weight of complying elements farther away from the SDE when calculating the score.

If the scanning light is known to result in a scan path (21′ in FIG. 3A) from left to right on the sensor array, the kernel may be defined to ignore filter values to the right of the SDE. For example, such a 3×3 kernel may be defined as:

$$ω 3 = [ \begin{matrix}1 & 0 & 0 \\ 1 & 0 & 0 \\ 1 & 0 & 0\end{matrix} ]$$

The foregoing examples are not intended to be limiting. Many variants are readily apparent to the skilled person.

Reverting to FIG. 6, steps 424-426 are part of step 404 in FIG. 6 and corresponds to step 412 in FIG. 5. Steps 424-426 selectively output a filtered event based on the score generated in step 423. In step 424, the score is compared to a range, which has been defined to differentiate between events originating from a voxel being hit by the light beam and other events, as described above with reference to step 411. If the score is within the range, the current event is output as part of the filtered event stream (step 425), otherwise the current event is dropped (step 426). The procedure then returns to step 420, to input and process another event in the event stream.

In a non-limiting example, when using a 3×3 search area, it may be reasonable for steps 424-426 to output an event if the search area includes at least one and not more than 2 complying elements, and otherwise drop the event. When using f2(i,j) and ω1 as defined above, this corresponds to passing an event that results in a score in the range [1,2].

FIG. 8B illustrates the efficacy of the spatio-temporal filtering as described hereinabove. FIG. 8B corresponds to FIG. 8A but shows a filtered event stream in a 2D map that corresponds to the sensor array. The filtered event stream has been generated by the procedure shown in FIG. 6. FIG. 8B thus indicates, by light dots, pixels that are activated according to the filtered event stream. In comparison to FIG. 8A, the impact of ambient light and secondary scattering is effectively eliminated.

FIG. 3C is a block diagram of an example implementation of the filtering technique in the system of FIG. 1. The event cameras 30, 40, 50 generate a respective event stream ES1, ES2, ES3, which is received by a respective filtering device 130, 140, 150. Each filtering device 130, 140, 150 comprises an input interface I1 and an output interface I2 and is configured to process the incoming event stream ES1, ES2, ES3 in accordance with the method 400 in FIG. 4. Each filtering device 130, 140, 150 generates and outputs a filtered event stream FES1, FES2, FES3. A voxel determination device 160 is arranged to receive FES1, FES2 and FES3 and determine the position of voxels rep, in accordance with step 204 in FIG. 2. The filtering devices 130,140, 150 may be seen to define a filtering arrangement 100. With reference to FIG. 1, the filtering arrangement 100 and the voxel determination device 160 may be included in the processing system 60. As mentioned with reference to FIG. 1, a different number of event cameras may be used, and the system may be implemented for other purposes than position determination, by configuring the device 160 accordingly.

The present Applicant has found that the procedure 404 in FIG. 4 may be modified to also determine the direction of the scan path across the sensor array. Such information may, for example, be used to differentiate between light beams that are scanned across the scene in different directions. FIG. 9 is a flow chart of an example procedure 430 that may be part of the spatio-temporal filtering step 404 in FIG. 5. Specifically, the procedure 430 assumes the provision of filter values, as generated by step 422 in FIG. 6. Further, the procedure 430 involves use of so-called gradient kernels. A gradient kernel is a conventional convolution matrix that is configured to enhance structures in a particular direction in an image. In the procedure 430, a gradient kernel is applied to quantify the gradient of the filter values in a specific direction. For example, the following gradient kernels Gi and Gj may be applied to quantify the gradient from left to right and the gradient from top to bottom, respectively, in the examples of FIGS. 7A-7D:

$$Gi = [ \begin{matrix}1 & 0 & - 1 \\ 2 & 0 & - 2 \\ 1 & 0 & - 1\end{matrix} ]$$

$$Gj = [ \begin{matrix}1 & 2 & 1 \\ 0 & 0 & 0 \\ - 1 & - 2 & - 1\end{matrix} ]$$

These examples are not intended to be limiting. Many variants of gradient kernels are readily apparent to the skilled person.

In step 431, a first gradient kernel is applied to the filter values of the search area to generate a first gradient magnitude (GM1) for a first direction in relation to the sensor array. The first gradient kernel may be given by Gi. In step 432, a second gradient kernel is applied to the filter values of the search area to generate a second gradient magnitude (GM2) for a second direction in relation to the sensor array. The second gradient kernel may be given by Gj. The first and second directions are non-parallel and may, but need not, be mutually orthogonal. For computational simplicity, the first and second direction may be aligned with rows and columns of pixels in the sensor array. In step 433, a time-gradient direction is determined based on the gradient magnitudes. The time-gradient direction corresponds to the direction of the scan path (21′ in FIG. 3A) across the sensor array and is thus a “scanning direction”. The scanning direction may be calculated by a trigonometric formula. In the example above, the scanning direction may be given as θ=arctan (GM1/GM2), where θ=0 indicates that the scan path is horizontal and moves from left to right. If desired, the procedure 430 may also comprise a step (not shown) of calculating the total magnitude of the gradient based on the gradient magnitudes, for example as G=\sqrt{GM1²+GM2²}. In step 434, which may be part of step 425 in FIG. 6, the scanning direction is added to the current event before the current event is output and included in the filtered event stream. The scanning direction may be given by θ, or any corresponding index. Steps 431-433 may also be part of step 425, so that the scanning direction is only determined for the events that have passed the evaluation of the score in step 424. Step 434 may also include the total magnitude, if calculated, in the current event.

The dashed boxes in FIG. 9 represent post-processing steps 438, 439, which may be performed by a device that receives the filtered event stream. In step 438, the trajectories of plural scan paths across the sensor array are reconstructed by use of the pixel location, the time value and the scanning direction of the respective filtered event. It should be noted that if two or more light beams are scanned across the scene at the same time, events belonging to different beams may be intermixed in the filtered event stream. By use of the scanning direction, it is possible to reconstruct the trajectories of the different beams, provided that the beams are scanned in different directions across the scene. Step 439, which may be performed in combination with or instead of step 438, uses the scanning direction to differentiate between filtered events from different light beams. Step 439 does not recreate trajectories of scan paths but may, for example, use the scanning direction to split one single event stream into plural event streams corresponding to different light beams.

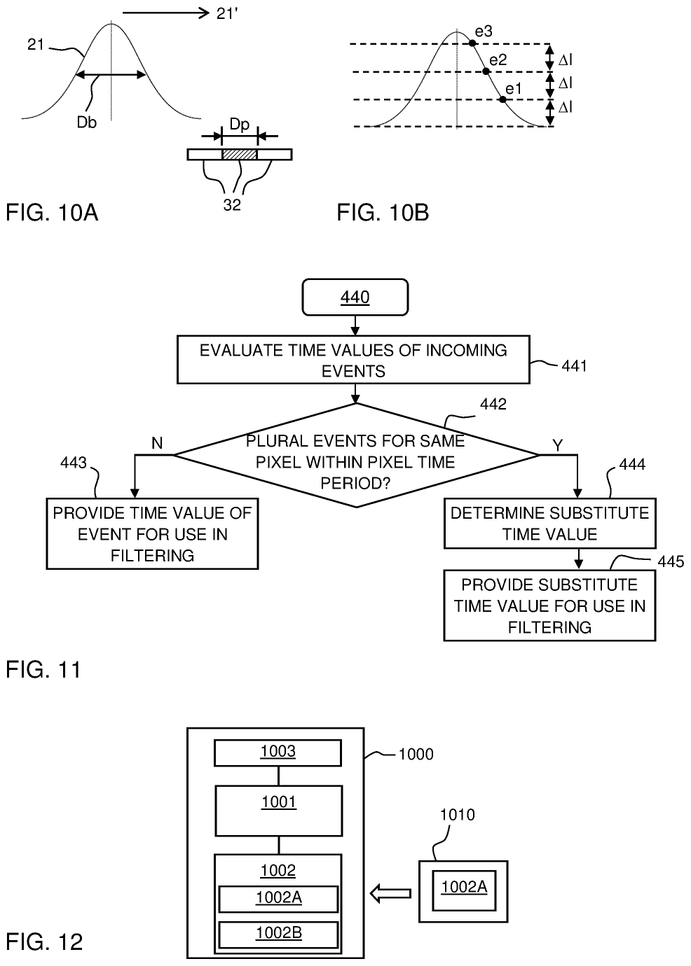

The present Applicant has also identified a procedure that may improve performance of the filtering technique when the extent (“spot size”) of the reflected scanning light on the sensor array is larger than an individual pixel. In this case, one and the same pixel may generate more than one event as the reflected scanning light moves on the scan path (cf. 21′ in FIG. 3A). FIG. 10A shows an example intensity profile 21 of the reflected scanning light on the sensor array. In the illustrated example, the intensity profile is approximately Gaussian and has a width Db (FWHM, full width at half maximum). The individual pixels 32 on the sensor array have a width of Dp, which is smaller than Db. Depending on event camera, each pixel may generate a plurality of events as the intensity profile 21 moves in direction 21′. FIG. 10B shows a sequence of events e1, e2, e3 that may be generated over time by the dark pixel in FIG. 10A if configured to generate an event whenever intensity (number of photons) changes by Al. It is also conceivable that corresponding events are generated by the pixel for the trailing end of the intensity profile 21, as the pixel senses a corresponding decrease in intensity. It is realized that the rate of events in the event stream may be increased significantly if the spot size exceeds the pixel size. This will result in an increased processing load on both the filtering and the downstream processing. At the same time, the added events contain mostly redundant information.

This problem is addressed by the example procedure 440 in FIG. 11, which is performed in advance of the spatio-temporal filtering. In step 441, time values of incoming events are evaluated to detect plural events that are generated by the same pixel with a small temporal spacing. The temporal spacing is given by the difference between the time stamps of the incoming events. Specifically, step 441 may determine if the temporal spacing is less than a pixel time period (PTP). Stated differently, step 441 may determine if there are plural events from the same pixel within PTP. The PTP is a limiting time period, which may be set to be smaller than the above-mentioned expected residence time for a single pixel, and preferably significantly smaller. If there are plural events from an individual pixel within PTP, the events are likely to be generated as one scan spot moves across the pixel (cf. e1, e2, e3 in FIG. 10B). For pixels that are found not to have generated plural events within PTP, step 442 directs the procedure to step 443, which provides the time value of the respective event for use in the filtering. On the other hand, if a pixel is found to have generated plural (two or more) events within PTP, step 442 directs the procedure to step 444, which determines a substitute time value based on the time stamps of the plural events. In some embodiments, step 444 selects one of these time stamps as the substitute time value. In some embodiments, the first time stamp is selected as substitute, i.e. the smallest time stamp. The Applicant has found that, in some situations, significant improvement of the accuracy of the filtered event stream may be achieved by selecting a time stamp other than the first time stamp. Thus, step 444 may involve identifying the n:th smallest time stamp (n>1) among the time stamps of the plural events, and setting the substitute time value to the n:th smallest time stamp. For example, good results have been achieved with n=2, i.e. the second smallest time stamp. The improvement may be understood from FIG. 10B. Since e2 is activated closer to the peak of the intensity profile 21, it is a more robust representation of the activated pixel than e1. In some embodiments, step 444 generates the substitute time value as a combination of two or more time stamps of the plural events, for example an average. In step 445, the substitute time value is provided for use in the filtering.

The procedure 440 may be implemented in different ways. In a first alternative, the procedure 440 is performed before step 402 in FIG. 4, or intermediate steps 420 and 421 in FIG. 6. Thus, steps 444 and 445 provide time values for filtering, by providing them for update of the TDM. In a second alternative, the procedure 440 is included in step 403 in FIG. 4 or step 421 in FIG. 6. For example, each data element in the TDM may be configured to a store a plurality of consecutive time values for each data element, and step 403/421 may perform the procedure 440 to provide time values for subsequent step 404/422. In another example, each data element in the TDM may include a counter which is selectively increased and reset based on time difference between consecutive events for the data element. The value of the counter may be used to trigger step 444 and step 445, respectively. In a third alternative, the procedure 440 is included in step 404 in FIG. 4 or step 422 in FIG. 6. For example, step 422 may retrieve time values from the TDM and perform the procedure 440 before applying the TFF.

FIG. 12 is a block diagram of an exemplifying structure of a filtering device 1000, for example corresponding to any one of the devices 130,140, 150 in FIG. 3C. Generally, the filtering device 1000 may be configured to perform any of the methods, procedures and functions described herein, or part thereof, by a combination of software and hardware circuitry, or exclusively by specific hardware circuitry. The Applicant has estimated that the filtering technique may be implemented on a regular FPGA, resulting in less than 1 s in processing time per event. In FIG. 12, the filtering device 1000 comprises a processing device or processor 1001, which may be or include a central processing unit (CPU), graphics processing unit (GPU), microcontroller, microprocessor, ASIC, FPGA, or any other specific or general processing device. The processor 1001 may execute instructions 1002A stored in a separate memory, such as memory 1002, in order to control the operation of the filtering device 1000. The instructions 1002A when executed by the processor 1001 may cause the filtering device 1000 to perform any of the methods described herein, or part thereof. The instructions 1002A may be supplied to the filtering device 1000 on a computer-readable medium 1010, which may be a tangible (non-transitory) product (for example magnetic medium, optical disk, read-only memory, flash memory, etc.) or a propagating signal. As indicated in FIG. 12, the memory 1002 may also store data 1002B for use by the processor 1001, for example one or more parameter values, functions or limits such as a kernel, TFF, TD, etc. The memory 1002 may comprise one or more of a buffer, flash memory, hard drive, removable media, volatile memory, non-volatile memory, random access memory (RAM), or another suitable data storage device. Such a memory 1002 is considered a non-transitory computer readable medium. The filtering device 40 may further include an I/O interface 1003, which may include any conventional communication interface for wired or wireless communication.

While the subject of the present disclosure has been described in connection with what is presently considered to be the most practical embodiments, it is to be under-stood that the subject of the present disclosure is not to be limited to the disclosed embodiments, but on the contrary, is intended to cover various modifications and equivalent arrangements included within the spirit and the scope of the appended claims.

Further, while operations are depicted in the drawings in a particular order, this should not be understood as requiring that such operations be performed in the particular order shown or in sequential order, or that all illustrated operations be performed, to achieve desirable results.

In the following, clauses are recited to summarize some aspects and embodiments as disclosed in the foregoing.
C1. A computer-implemented method of filtering a data stream of events from an event-based sensor (30), which comprises a pixel array (31) and is arranged to receive photons reflected or scattered by a voxel on an object (1) when illuminated by a scanning light beam (21), wherein each event in the data stream originates from a pixel (32) in the pixel array (31) and comprises an identifier of the pixel (32) and a time stamp associated with the event, said method comprising: initiating (401) a data structure (131) with data elements (132) corresponding to pixels (32) of the pixel array (31); receiving (402) the data stream of events; updating (403) the data structure (131) to store time values in the data elements (132) based on the data stream of events, so that a respective time value of a data element (132) represents a most recent time stamp associated with the pixel (32) corresponding to the data element (132); and performing (404) a spatio-temporal filtering of the data structure (131) to determine a filtered data stream of events.
C2. The method of C1, wherein said spatio-temporal filtering comprises: evaluating (410), for a selected data element (132′) in the data structure (131), data elements within a search area (132″) around the selected data element (132′) to identify one or more data elements that store a time value with a predefined time difference to a reference time value stored in the selected data element (132′); generating (411) a score for the search area (132″) based on the one or more data elements; and selectively outputting (411), based on the score, a filtered event representing the selected data element (132′).
C3. The method of C2, wherein said evaluating (410) is performed when the data structure (131) has been updated based on a current event in the data stream.
C4. The method of C3, wherein the selected data element (132′) is a data element that is updated based on the current event.
C5. The method of any one of C2-C4, wherein said evaluating (410) is repeated for each event in the data stream.
C6. The method of any one of C2-C5, wherein the score is generated (411) as function of the number of identified data elements in the search area (132″), for example as a weighted sum of the number of identified elements at different distances from the selected data element (132′).
C7. The method of any one of C2-C6, wherein said evaluating (410) comprises: operating (422) a temporal filter function on the time value of a respective data element other than the selected data element (132′) in the search area (132″) to generate a filter value of the respective data element, wherein the temporal filter function is configured to generate the filter value to selectively indicate, by the filter value, each data element that store time values with the predefined time difference to the reference time value.
C8. The method of C7, wherein the temporal filter function is configured to set the filter value to zero for time values that are outside the predefined time difference to the reference time value, and to set the filter value to non-zero for time values that have the predefined time difference to the reference time value.
C9. The method of C7 or C8, wherein the score is generated as a weighted combination of filter values for the data elements (132) in the search area (132″).
C10. The method of C9, wherein said generating (411) the score comprises: operating a predefined kernel (134) on the filter values for the data elements in the search area (132″).
C11. The method of C10, wherein the predefined kernel (134) is defined based on a known scan direction of the scanning light beam in relation to the pixel array (31).
C12. The method of any one of C7-C11, further comprising: generating (431) a first magnitude as a first weighted combination of filter values within the search area (132″) in respect of a first direction, generating (432) a second magnitude as a second weighted combination of the filter values within the search area (132″) in respect of a second direction which is different from the first direction, and determining (433) a scan direction of light across the pixel array (31) based on the first and second magnitudes.
C13. The method of C12, further comprising: including (434) the scan direction in the filtered event.
C14. The method of any one of C2-C13, wherein the predefined time difference corresponds to an expected residence time of the scanning light beam on a predefined number of pixels.
C15. The method of C14, wherein the predefined number is one.
C16. The method of C14 or C15, wherein the predefined time difference is given as a range around the expected residence time.
C17. The method of any one of C2-C16, wherein the filtered event is output if the score is within a score range.
C18. The method of any one of C2-C17, wherein the search area (132″) has a predefined size.
C19. The method of any one of C2-C18, wherein the search area (132″) is centered on the selected data element (132′).
C20. The method of any preceding clause, which further comprises: evaluating (441) the events for detection of plural events that are generated by an individual pixel within a limiting time period, determining (444), upon said detection, a substitute time value for said individual pixel based on time stamps included in the plural events, and providing (445) the substitute time value for use in the spatio-temporal filtering.
C21. The method of C20, wherein the limiting time period is set to be smaller than an expected residence time of the scanning light beam on the individual pixel.
C22. The method of C20 or C21, wherein said determining (444) the substitute time value comprises: identifying an n:th smallest time stamp among the time stamps included in the plural events, with n being larger than 1, and setting the substitute time value to the n:th smallest time stamp.
C23. The method of any preceding clause, wherein the spatio-temporal filtering is performed (404) based on a known speed of the scanning light beam (21).
C24. A computer-readable medium comprising computer instructions which, when executed by a processor (1001), cause the processor (1001) to the perform the method of any one of C1-C23.
C25. A processing device, which comprises an interface (I1) for receiving a data stream of events from an event-based sensor (30; 40; 50) and is configured to perform the method of any one of C1-C23.
C26. The processing device of C25, which is or comprises an FPGA or an ASIC.
C27. A system for determining a position of an object (1), said system comprising: at least one beam scanning device (20) configured to generate a scanning light beam (21) to illuminate the object (1); at least one event-based sensor (30, 40, 50) that comprises a pixel array (31, 41, 51) and is arranged to receive photons reflected or scattered by a voxel on the object when illuminated by the scanning light beam (21), wherein said at least one event-based sensor (30, 40, 50) is configured to generate an event for a pixel (32) in the pixel array (31, 41, 51) when a number of photons received by the pixel (32) exceeds a threshold, wherein said at least one event-based sensor (30, 40, 50) is configured to output events as a respective data stream, wherein each event in the respective data stream comprises an identifier of the pixel (32) and a time stamp associated with the event; a processing arrangement (100), which comprises at least one processing device in accordance with C22 or C23 and is configured to receive the respective data stream from the at least one event-based sensor (30, 40, 50) and output a respective filtered data stream; and a voxel detection device (160) configured to receive the respective filtered data stream and determine the position of the voxel based thereon.

Any one of C2-C23 may be adapted and included as an embodiment of C27.

1. A computer-implemented method of filtering a data stream of events from an event-based sensor, which comprises a pixel array and is arranged to receive photons reflected or scattered by a region on an object when illuminated by a scanning light beam, wherein each event in the data stream originates from a pixel in the pixel array and comprises an identifier of the pixel and a time stamp associated with the event, said method comprising:
initiating a data structure with data elements corresponding to pixels of the pixel array;
receiving the data stream of events;
updating the data structure to store time values in the data elements based on the data stream of events, so that a respective time value of a data element represents a most recent time stamp associated with the pixel corresponding to the data element; and
performing a spatio-temporal filtering of the data structure to determine a filtered data stream of events,
wherein said spatio-temporal filtering comprises:
evaluating, for a selected data element in the data structure, data elements within a search area around the selected data element to identify one or more data elements that store a time value with a predefined time difference to a reference time value stored in the selected data element,
generating a score for the search area based on the one or more data elements, and
selectively outputting, based on the score, a filtered event representing the selected data element.

2. (canceled)

3. The method of claim 1, wherein said evaluating is performed when the data structure has been updated based on a current event in the data stream.

4. The method of claim 3, wherein the selected data element is a data element that is updated based on the current event.

5. The method of claim 1, wherein said evaluating is repeated for each event in the data stream.

6. The method of claim 1, wherein the score is generated as function of the number of identified data elements in the search area.

7. The method of claim 6, wherein the score is generated as a weighted sum, in which the respective identified element is weighted by its distance to the selected data element.

8. The method of claim 1, wherein said evaluating comprises: operating a temporal filter function on the time value of a respective data element other than the selected data element in the search area to generate a filter value of the respective data element, wherein the temporal filter function is configured to generate the filter value to selectively indicate, by the filter value, each data element that stores time values with the predefined time difference to the reference time value.

9. (canceled)

10. The method of claim 8, wherein the score is generated as a weighted combination of filter values for the data elements in the search area.

11. The method of claim 10, wherein said generating the score comprises: operating a predefined kernel on the filter values for the data elements in the search area.

12. The method of claim 11, wherein the predefined kernel is defined based on a known scan direction of the scanning light beam in relation to the pixel array.

13. The method of claim 1, further comprising: generating a first magnitude as a first weighted combination of filter values within the search area in respect of a first direction, generating a second magnitude as a second weighted combination of the filter values within the search area in respect of a second direction which is different from the first direction, and determining a scan direction of light across the pixel array based on the first and second magnitudes, and
including the scan direction in the filtered event.

14. (canceled)

15. The method of claim 1, wherein the predefined time difference corresponds to an expected residence time of the scanning light beam on a predefined number of pixels.

16-17. (canceled)

18. The method of claim 1, wherein the filtered event is output if the score is within a score range.

19. (canceled)

20. The method of claim 1, wherein the search area is centered on the selected data element.

21. The method of claim 1, which further comprises: evaluating the events for detection of plural events that are generated by an individual pixel within a limiting time period, determining, upon said detection, a substitute time value for said individual pixel based on time stamps included in the plural events, and providing the substitute time value for use in the spatio-temporal filtering.

22. The method of claim 21, wherein the limiting time period is set to be smaller than an expected residence time of the scanning light beam on the individual pixel.

23. The method of claim 22, wherein said determining the substitute time value comprises: identifying an n:th smallest time stamp among the time stamps included in the plural events, with n being larger than 1, and setting the substitute time value to the n:th smallest time stamp.

24. The method of claim 1, wherein the spatio-temporal filtering is performed based on a known speed of the scanning light beam.

25. (canceled)

26. A processing device, which comprises an interface for receiving a data stream of events from an event-based sensor and is configured to perform the method of claim 1.

27. (canceled)

28. A system for determining a position of an object, said system comprising:
at least one beam scanning device configured to generate a scanning light beam to illuminate the object;
at least one event-based sensor that comprises a pixel array and is arranged to receive photons reflected or scattered by a region on the object when illuminated by the scanning light beam,
wherein said at least one event-based sensor is configured to generate an event for a pixel in the pixel array when a number of photons received by the pixel exceeds a threshold, and
wherein said at least one event-based sensor is configured to output events as a respective data stream, wherein each event in the respective data stream comprises an identifier of the pixel and a time stamp associated with the event;
the system further comprising a processing arrangement, which comprises at least one processing device in accordance with claim 26 and is configured to receive the respective data stream from the at least one event-based sensor and output a respective filtered data stream; and
a detection device configured to receive the respective filtered data stream and determine the position of the region based thereon.
